(19) United States
(12) Patent Application Publication
(10) Pub. No.: US 2018/0174205 A1
(43) Pub. Date: Jun. 21, 2018

(54) SYSTEMS AND METHODS FOR RECOMMENDING MERCHANTS TO A CONSUMER

(71) Applicant: Capital One Financial Corporation, McLean, VA (US)

(72) Inventors: Philip KIM, New York, NY (US); Homin LEE, Jersey City, NJ (US); Alexander HASHA, Brooklyn, NY (US); Chi Tak KWOK, New Rochelle, NY (US); Jaidev SHERGILL, New York, NY (US)

(73) Assignee: Capital One Financial Corporation, McLean, VA (US)

(21) Appl. No.: 15/896,792

(22) Filed: Feb. 14, 2018

Related U.S. Application Data
(63) Continuation of application No. 14/305,294, filed on Jun. 16, 2014.
(60) Provisional application No. 61/836,524, filed on Jun. 18, 2013.

(51) Int. Cl. G06Q 30/02

(52) U.S. Cl. CPC G06Q 30/0282

(57) ABSTRACT

The disclosed embodiments include systems and methods for generating merchant recommendations for a user. In one embodiment, the disclosed embodiments may include one or more memory devices storing software instructions and one or more processors configured to execute the software instructions to perform operations consistent with the disclosed embodiments. In one aspect, the one or more processors may be configured to receive consumer transaction data associated with a plurality of consumer purchases from at least one data source and store the received consumer transaction data in the one or more memory devices. In another embodiment, the one or more processors may be configured to identify a plurality of merchant recommendations based on the stored consumer transaction data and one or more attributes associated with each of a plurality of merchants. The processor(s) may also be configured to generate corresponding recommendation scores for each of the identified plurality of merchant recommendations based on one or more recommendation models. The one or more processors may further provide the plurality of merchant recommendations and corresponding recommendation scores to the user.

### PRIORITY CLAN

This application claims priority under 35 U.S.C. § 119 to U.S. provisional patent application No. 61/836,524, filed on Jun. 18, 2013, and entitled “Systems and Methods for Recommending Merchants to a Consumer.” The aforementioned application is incorporated herein by reference in its entirety.

### BACKGROUND

Consumers may find that it has become increasingly difficult to choose a merchant from the growing number of merchants in various industries. Typically, merchants mail promotions and/or brochures to the mailboxes of consumers in batches. Merchants also send advertising material to consumers via websites, emails, and the like. The problem with these traditional ways of advertising and/or merchant recommendation mechanisms is that no particular study of the consumers is being done, and the data used to predict the preferences of the consumers are not comprehensive enough to predict their spending activities. Consequently, most of the Promotions and the advertising material sent in the traditional way end up being junk mail/spam or not the recommendations for which the consumers are looking.

Moreover, with the widespread use of portable electronic devices, consumers may need to receive merchant recommendations real time. For example, a situation may arise in which a consumer is in a neighborhood that he/she has never been to before, and the consumer needs to find a restaurant that suits his/her taste. Existing technologies do not provide mechanisms to provide merchant recommendations in real time, let alone provide recommendations that are tailored to the particular needs of a consumer in real time.

### SUMMARY

The disclosed embodiments include, for example, a system for generating merchant recommendations for a user, comprising one or more memory devices storing software instructions, and one or more processors configured to execute the software instructions to perform functions for generating merchant recommendations. In some embodiment, the one or more processors are configured to receive consumer transaction data associated with a plurality of consumer purchases from at least one data source; store the received consumer transaction data in the one or more memory devices; identify a plurality of merchant recommendations based on the stored consumer transaction data and one or more attributes associated with each of a plurality of merchants; generate corresponding recommendation scores for each of the identified plurality of merchant recommendations based on one or more recommendation models; and provide the plurality of merchant recommendations and corresponding recommendation scores to the user.

The disclosed embodiments also include a computer-implemented method for generating merchant recommendations for a user, comprising receiving, via at least one processor, consumer transaction data associated with a plurality of consumer purchases from at least one data source; storing the received consumer transaction data in the one or more memory devices; identifying a plurality of merchant recommendations based on the stored consumer transaction data and one or more attributes associated with each of a plurality of merchants; generating corresponding recommendation scores for each of the identified plurality of merchant recommendations based on one or more recommendation models; and providing the plurality of merchant recommendations and corresponding recommendation scores to the user.

The disclosed embodiments also include a non-transitory computer-readable medium including computer instructions, which, when executed by a processor, cause a processor to perform operations for providing merchant recommendations to a consumer. In one aspect, the method may include receiving, via at least one processor, consumer transaction data associated with a plurality of consumer purchases from at least one data source; storing the received consumer transaction data in the one or more memory devices; identifying a plurality of merchant recommendations based on the stored consumer transaction data and one or more attributes associated with each of a plurality of merchants; generating corresponding recommendation scores for each of the identified plurality of merchant recommendations based on one or more recommendation models; and providing the plurality of merchant recommendations and corresponding recommendation scores to the user.

It is to be understood that both the foregoing general description and the following detailed description are exemplary and explanatory only and are not restrictive of the disclosed embodiments, as claimed.

### BRIEF DESCRIPTION OF THE DRAWING

The accompanying drawings, which are incorporated in and constitute a part of this specification, illustrate disclosed embodiments and together with the description, serve to explain the disclosed embodiments.

FIG. 1 is a block diagram of an exemplary system, consistent with disclosed embodiments.

FIG. 2 is a block diagram of an exemplary financial service provider system, consistent with disclosed embodiments.

FIG. 3 is a flowchart of an exemplary process for providing merchant recommendations to a consumer, consistent with disclosed embodiments.

FIG. 4 illustrates two exemplary tables showing consumer transaction data stored in a database, consistent with disclosed embodiments.

FIGS. 5A-5C illustrate exemplary data for generating merchant recommendations, consistent with disclosed embodiments.

FIG. 6 illustrates an exemplary table showing rating scores given by a plurality of consumers, consistent with disclosed embodiments.

FIG. 7 illustrates an exemplary interface screen providing merchant recommendations for a consumer, consistent with disclosed embodiments.

### DETAILED DESCRIPTION

It is to be understood that the following detailed description is exemplary and explanatory only and is not restrictive of disclosed embodiments. For example, steps or processes disclosed herein are not limited to being performed in the order described, but may be performed in any order, and that some steps may be omitted, consistent with the disclosed embodiments.

Reference will now be made in detail to the disclosed embodiments, examples which are illustrated in the accompanying drawings. Wherever convenient, the same reference numbers will be used throughout the drawings to refer to the same or like parts.

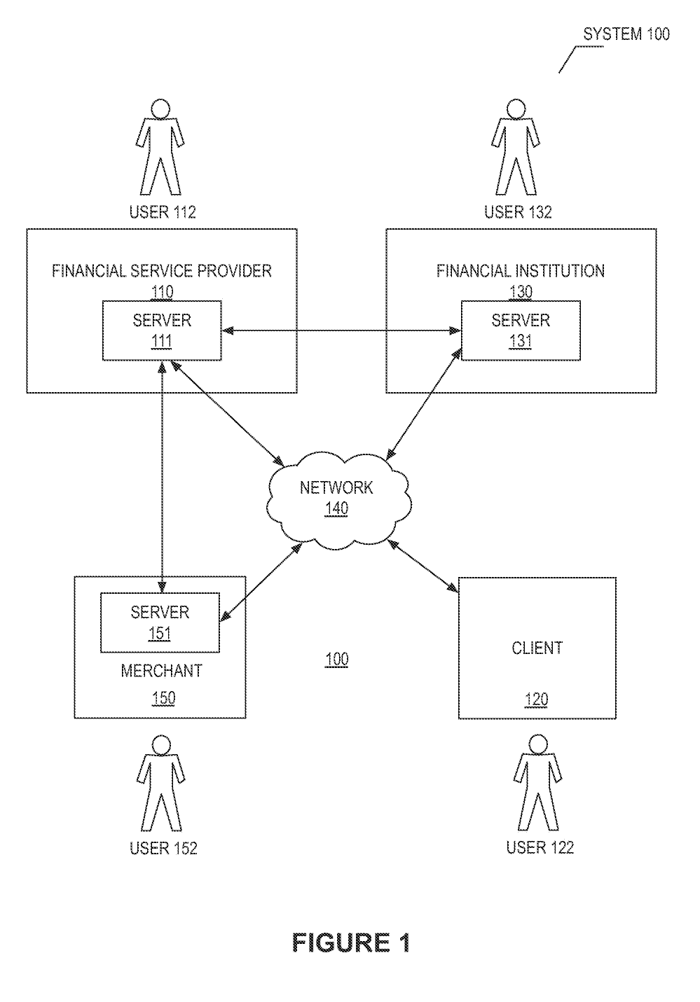

FIG. 1 is a block diagram illustrating an exemplary system 100 for performing one or more operations, consistent with the disclosed embodiments. In one embodiment, system 100 may include a financial service provider 110, a client 120, a financial institution 130, a network 140, and a merchant 150. The components and arrangement of the components included in system 100 may vary. Thus, system 100 may further include one or more of the components of system 100 or other components that perform or assist in the performance of one or mere processes consistent with the disclosed embodiments.

Financial service provider 110 may be an entity that provides financial services. For example, financial service provider 110 may be a bank, credit card issuer, or other type of financial service entity that generates, provides, manages, and/or maintains financial service accounts for one or more users. Financial service accounts may include, for example, credit card accounts, checking accounts, savings accounts, reward accounts, and any other types of financial service accounts known to those skilled in the art. Financial service accounts may be associated with electronic accounts such as a digital wallet or similar accounts that may be used to perform electronic transactions, such as purchasing goods and/or services online. Financial service accounts may also be associated with physical financial service account cards, such as a plastic credit or check card that a user may carry and use to perform financial service transactions, such as purchasing goods and/or services at a point-of-sale (POS) terminal. Financial service provider 110 may include infrastructure and components that are configured to generate and provide financial service accounts and financial service account cards (e.g., credit cards, check cards, etc.). Financial service provider 110 may also include infrastructures and components that are configured to store transactional data associated with the financial service, accounts, and thereby to make merchant recommendations to the users possessing the financial service accounts.

Financial service provider 110 may include one or more computing systems that are configured to execute software instructions stored on one or more memory devices to perform one or more operations consistent with the disclosed embodiments. In one embodiment, financial service provider 110 may include a server 111. Server 111 may be one or more computing devices configured to execute software instructions stored in memory devices to perform one or more processes consistent with the disclosed embodiments. For example, server 111 may include one or more memory devices storing data and software instructions, and one or more processors configured to use the data and execute the software instructions to perform server-based functions and operations known to those skilled in the art. Server 111 may also be configured to execute stored software instructions to perform operations associated with recommending merchants to consumers based on the transactional behaviors of the consumers in a manner consistent the disclosed embodiments. Server 111 may be a general-purpose computer, a mainframe computer or any combination of these components. Server 111 may be a standalone server, or may be of a subsystem, which may be part of a larger system. For example, server 111 may represent distributed servers that are remotely located end communicate over a network (e.g., network 140) or a dedicated network, such as a LAN, for financial service provider 110. In certain aspects, server 111 may be configured as a particular machine when executing software instructions to perform one or more operations consistent with disclosed embodiments.

Server 111 may include or may connect to one or more storage devices configured to store data and/or software instructions used by one or more processors of server 111 to perform operations consistent with the disclosed embodiments. For example, server 111 may include memory configured to store one or more software programs that perform several functions when executed by a processor. The disclosed embodiments are not limited to separate programs or computers configured to perform dedicated tasks. For example, server 111 may include memory that stores a single program or multiple programs. Additionally, server 111 may execute one or more programs located remotely from server 111. For example, server 111 may access one or more remote programs stored in memory included with a remote component that, when executed, perform operations consistent with the disclosed embodiments. In certain aspects, server 111 may include web server software that generates, maintains, and provides website(s) that are accessible over network 140. In other aspects, financial service provider 110 may connect separate web server(s) or similar computing devices that generate, maintain, and provide website(s) for financial service provider 110.

In certain aspects, a user 112 may operate one or more components of financial service provider 110 (e.g., server 111) to perform one or more operations consistent with the disclosed embodiments. In one aspect, user 112 may be an employee of, or associated with, financial service provider 110 (e.g., someone authorized to use components of server 111 or perform processes for financial service provider 110). In other aspects, user 112 may not be an employee of financial service provider 110, but is otherwise associated with financial service provider 110.

Client 120 may be one or more computing devices that are configured to execute software instructions for performing one or more operations consistent with the disclosed embodiments. Client 120 may be a desktop computer, a laptop, a server, a mobile device (e.g., tablet, smartphone, etc.), and/or any other type of computing device. Client 120 may include one or more processors configured to execute software instructions stored in memory, such as memory included in client 120. Client 120 may include software that, when executed by a processor, performs known internet-related communication and content display processes. For instance, client 120 may execute browser software that generates and displays interface screens including content on a display device included in, or connected to, client 120. The disclosed embodiments are not limited to any particular configuration of client 120. For instance, client 120 may be a mobile device that stores and executes mobile applications that provide financial-service-related functions offered by financial service provider 110, such as an application for receiving merchant recommendations from financial service provider 110.

In one embodiment, a user 122 may use client 120 to perform one or more operations consistent with the disclosed embodiments. In one aspect, user 122 may be a customer of financial se ice provider 110. For instance financial service provider 110 may maintain a financial service account (e.g., credit card account) for user 122 that user 122 may use to purchase goods and/or services online or at brick-and-mortar locations associated with a merchant (e.g., merchant 150). In other embodiments, user 122 may be a potential customer of financial service provider 110 or may not be affiliated with financial service provider 110 from the perspective of user 122 and/or the perspective of financial service provider 110. For example, user 122 may be a consumer who does not have a financial service account with financial service provider 110, but needs merchant recommendations and it staff an application on client 120 to receive merchant recommendations from financial service provider 110.

According to the illustrated embodiments, financial institution 130 may be an entity that provides financial services consistent with the disclosed embodiments. For example, financial institution 130 may be a bank, credit card issuer, or other type of financial service entity that generates, provides, manages, ardor maintains financial service accounts for one or more users. As another example, financial institution 130 may be an entity that gathers consumer transaction data and provides such data to other entities, such as, for example, financial service provider 110. In one aspect, financial institution 130 may include one or more computer system(s) that are configured to execute software instructions. As an example, financial institution 130 may include a server 131. Server 131 may be one or more computing devices configured to execute software instructions stored in memory to perform one or more processes consistent with the disclosed embodiments. For example, server 131 may include one or more memory device(s) storing data and software instructions, and one or more processor(s) configured to use the data and execute the software instructions to perform server-based functions and operations known to those skilled in the art. Server 131 may also be configured to execute stored software instructions to perform operations associated with gathering consumer transaction data and providing the gathered consumer transaction data to financial service provider 110. Server 131 may be a general-purpose computer, a mainframe computer, or any combination of these components. Server 131 may be a standalone server, or may be part of a subsystem, which may be part of a larger system. For example, server 131 may represent distributed servers that are remotely located and communicate over a network (e.g., network 140) or a dedicated network, such as a LAN, for financial institution 130. In certain aspects, server 131 may be configured as a particular machine when executing software instructions to perform one or more operations consistent with disclosed embodiments.

Server 131 may include or may connect to one or more storage devices configured to store data (e.g., consumer transaction data) and/or software instructions used by one or more processors of server 131 to perform operations consistent with disclosed embodiments. For example, server 131 may include memory configured to store one or more software programs that perform several functions when executed by a processor. The disclosed embodiments are not limited to separate programs or computers configured to perform dedicated tasks. For example, server 131 may include memory that stores a single program or multiple programs. Additionally, server 131 may execute one or more programs located remotely from server 131. For example, server 131 may access one or more remote programs stored in memory included with a remote component that, when executed, perform operations consistent with the disclosed embodiments. In certain aspects, server 131 may include web server software that generates, maintains, and provides web site(s) that are accessible over network 140.

According to certain embodiments, server 131 may be configured to communicate with server 111 to provide consumer transaction data stored in the one or more memory device(s) of server 131. Server 131 may also be configured to receive a request from server 111 for consumer transaction data and respond to such a request by transmitting the requested consumer transaction data to server 111.

In exemplary embodiments, a user 132 may operate one or more components of financial institution 130 (e.g., server 131) to perform one or more operations consistent with the disclosed embodiments. For example, user 132 may be an employee of, or associated with, financial institution 130 (e.g., someone authorized to use components of server 131 or perform processes for financial institution 130 consistent with the disclosed embodiments).

Merchant 150 may be an entity that provides goods and/or services (e.g., a retail store). While FIG. 1 shows one merchant 150 in system 100, the disclosed embodiments may be implemented in a system involving a single merchant 150 or multiple merchants (e.g., two or more merchants). In one embodiment merchant 150 may include brick-and-mortar location(s) that a consumer (e.g., user 122) may physically visit and purchase goods and services. Such physical locations may include computing devices that perform financial service transactions with consumers (e.g., POS terminal(s), kiosks, etc.). Merchant 150 may also include a merchant who provides electronic shopping mechanisms, such as a website or a similar online location that consumers (e.g., user 122) may access using a computer (e.g., client 120) through browser software or similar software. Merchant 150 may include computing devices that may include back and/or front-end computing components that store consumer transaction data and execute software instructions to perform operations consistent with the disclosed embodiments, such as computers that are operated by employees of merchant 150 (e.g., back-office system, etc.).

In one embodiment, merchant 150 may include a server 151. Server 151 may be one or more computing devices configured to execute software instructions stored in memory to perform one or more processes consistent with the disclosed embodiments. For example, server 151 may include one or more memory device(s) storing data and software instructions and one or more processor(s) configured to use the data and execute the software instructions to perform server-based functions and operations known to those skilled in the art. Server 151 may also be configured to execute stored software instructions to perform operations associated with merchant 150, including one or more processes associated with gathering consumer transaction data. Server 151 may be a general-purpose computer, a mainframe computer, or any combination of these components. Server 151 may be a standalone server, or may be part of a subsystem, which may be part of a larger system. For example, server 151 may represent distributed servers that are remotely located and communicate over a network (e.g., network 140) or a dedicated network, such as a LAN, or merchant 150. In certain aspects, server 151 may be configured as a particular machine when executing software instructions to perform one or more operations consistent with disclosed embodiments

In certain aspects, server 151 may include web server software that generates, maintains, and provides websites for merchant 150 that are accessible over network 140. In other aspects, merchant 150 may connect separately to web server(s) or similar computing devices that generate, maintain, and provide website(s) for merchant 150. For example, merchant 150 may use web server(s) that provide a website specific to merchant 150, and allows consumers (e.g., user 122) to access, view, and purchase goods and/or services from merchant 150 via a computing device (e.g., client 120).

In accordance with certain aspects of the disclosed embodiments, merchant 150 may be configured to gather consumer transaction data associated with the business conducted at merchant 150. Consumers may make the payment by electronic payment cards (e.g., credit card or debit card issued by financial service provider 110) for the goods/services provided by merchant 150. In some other aspects, consumers may also make the payment by cash or other type of payment that does not establish any electronic record. In both situations, merchant 150 (via server 151) may be configured to store the consumer transaction data and provide the data to financial service provider 110 and/or financial institution 130. For example, server 151 may be configured to communicate with server 111 and/or server 131 and transmit data including, for example, consumer transaction data, description of merchant 150, service provided by merchant 150, etc., to financial service provider 110 and/or financial institution 130, respectively.

In certain embodiments, financial service provider 110 (e.g., via server 111) may be configured to execute software instructions that perform automated and/or semi-automated operations that determine and provide merchant recommendations for users. In certain aspects, financial service provider 110 may be configured to provide information and processes that assist merchant 150 with providing its goods/services to targeted consumers. For example, based on consumer transaction data, either provided by merchant 150 (via server 151) or financial institution 130 (via server 131), or gathered by financial service provided 110 (via server 111) itself, financial service provider 110 (e.g., via server 111) may be configured to provide merchant recommendations to user 122 via client 120. A merchant recommendation may include information that identifies a merchant, the merchant's business type, the product(s) and/or service(s) that are provided by the merchant, and other data that may be useful to a user in selecting a merchant for a purchase or service transaction. For instance, server 111 may execute software processes that determine end provide merchant recommendations to user 122 that includes merchant 150. Additionally or alternatively, server 151 may be configured to communicate with server 111 and/or server 131 to obtain data with respect to consumer preferences, and may be configured to disseminate its promotions and/or commercials based on the consumer preferences.

In exemplary embodiments, a user 152 may operate one or more components of merchant 150 (e.g., server 151) to perform one or more operations consistent with the disclosed embodiments. For example, user 152 may be an employee of, or associated with merchant 150 (e.g., someone authorized to use components of server 151 or perform processes for merchant 150 consistent with the disclosed embodiments).

Network 140 may be any type of network configured to provide communications between components of system 100. For example, network 140 may be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 may communicate directly through a dedicated communication link(s), such as the exemplary links between financial service provider 110 and merchant 150 and between financial service provider 110 and financial institution 130.

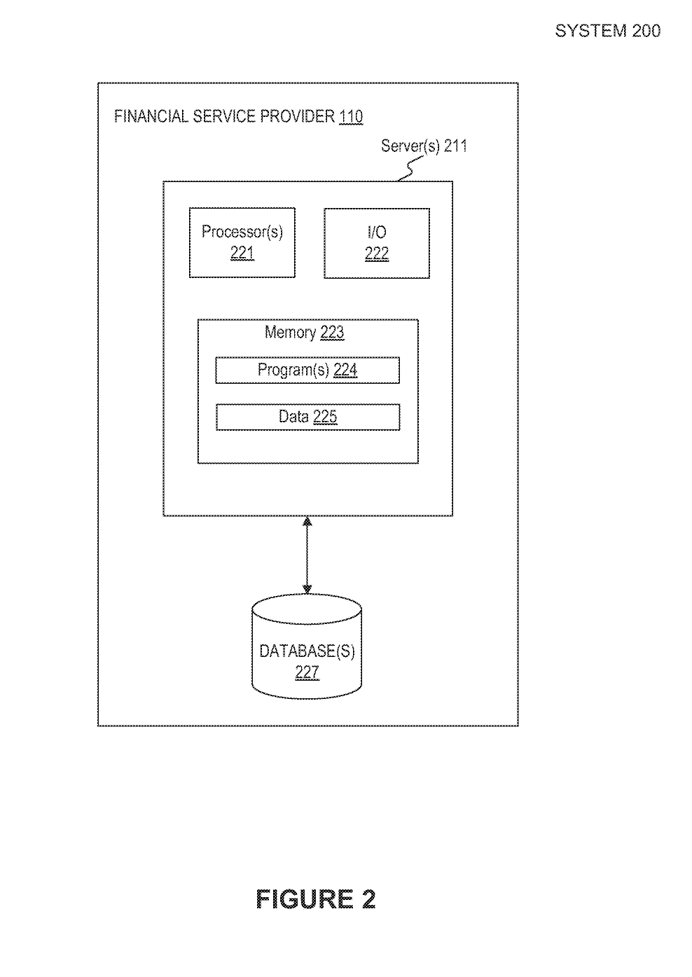

FIG. 2 is a block diagram illustrating an exemplary system 200 associated with financial service provider 110 for performing one or more operations, consistent with the disclosed embodiments. In one embodiment, financial service provider 110 may include a server 211. Server 211 may include one or more processors 221, one or more memories 223, and one or more input/output (I/O) devices 222. Server 211 may take the form of a general-purpose computer, a mainframe computer, or any combination of these components. Server 211 may be a standalone server, or may be part of a subsystem, which may be part of a larder system. Server 211 may correspond to server 111 shown in FIG. 1 and described above in connection with system 100. In certain aspects, server 211 may be configured as a particular machine when executing software instructions to perform one or more operations consistent with disclosed embodiments.

Processor 221 may be one or more known processing devices, such as a microprocessor from the Pentium™ family manufactured by Intel™ or the Turion™ family manufactured by AMD™. Processor 221 may include a single core or multiple core processor system that provides the ability to perform parallel processing. For example, processor 221 may be a single core processor that is configured virtual processing technologies known to those skilled in the art. In certain embodiments, processor 221 may use logical processors to simultaneously execute and control multiply processes. Processor 221 may implement virtual machine technologies, or other similar known technologies, to provide the ability to execute, control, run, manipulate, store, etc., multiple software processes, applications, programs, etc. In another embodiment, processor 221 includes a multiple-core processor arrangement (e.g., dual or quad core) that is configured to provide parallel processing functionalities to allow server 211 to execute multiple processes simultaneously. One of ordinary skill in the art would understand that other types of processor arrangements could be implemented that provide for the capabilities disclosed herein.

Memory 223 may include one or more storage devices configured to store instructions used by processor 221 to perform functions related to disclosed embodiments. For example, memory 223 may be configured with one or more software instructions, such program(s) 224 that may perform one or more operations when executed by processor 221. The disclosed embodiments are not limited to separate programs or computers configured to perform dedicated tasks. For example, memory 223 may include a single program 224 that performs the functions of the server 211, or program 224 could comprise multiple programs. Additionally, processor 221 may execute one or more programs located remotely from server 211. For example, financial service provider 110, via server 211 may access one or more remote programs that, when executed, perform functions related to certain disclosed embodiments.

Memory 223 may also store data 225 that may reflect any type of information in any format that financial service provider 110 may use to perform functions consistent with the disclosed embodiments. For example, data 225 may include financial service accounts of consumers (e.g., user 122), consumer transaction data, data relating to merchants (e.g., merchant 150), and other data enabling processor 221 to perform functions including providing merchant recommendations to a consumer, consistent with the disclosed embodiments.

I/O devices 222 may be one or more devices configured to allow data to be received and/or transmitted by server 211. I/O devices 222 may include one or more digital and/or analog communication devices that allow server 211 to communicate with other machines and devices, such as merchant 150 (via server 151) and/or financial institution 130 (via server 131).

Server 211 may also be communicatively connected to one or more database(s) 227. Server 211 may be communicatively connected to database(s) 227 through network 140. Database 227 may include one or more memory devices that store information and are accessed and/or managed through server 211. By way of example, database(s) 227 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. Additionally or alternatively, database 227 may be located remotely from financial service provider 110. Database 227 may include computing components (e.g., database management system, database server, etc.) configured to receive and process requests for data stored in memory devices of database(s) 227 and to provide data from database 227.

In exemplary embodiments, database 227 may store consumer transaction data received from financial institution 130 (via server 131) and/or merchant 150 (via server 151). In other embodiments, database 227 may store consumer transaction data associated with financial service accounts managed and/or maintained by financial service provider 110. According to the illustrated embodiments, processor 221 may be configured to retrieve consumer transaction data by analyzing data associated with the financial service accounts stored in database 227, and store the obtained consumer transaction data in database 227.

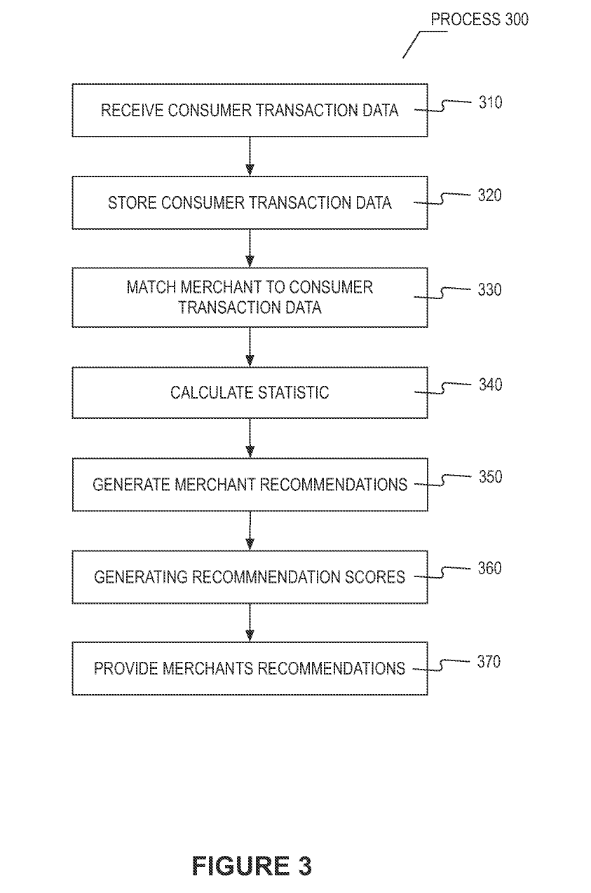

FIG. 3 is a flowchart of an exemplary process 300 for generating merchant recommendations for a user, consistent with the disclosed embodiments. In certain aspects, server 111/211 (e.g., processor 221) may be configured to execute software instructions that perform one or more of the operations of process 300.

In exemplary embodiments, server 211 (e.g., processor 221) may be configured to receive consumer transaction data for generating merchant recommendations for a user (e.g., step 310). In exemplary embodiments, server 211 (e.g., processor 221) may be configured to receive consumer transaction data associated with the financial service accounts that financial service provider 110 manages and/or maintains. For example, being a customer of financial service provider 110, a user (e.g., user 122) may have one or more debit cards, credit cards, and/or other financial service account generated and maintained by financial service provider 110. User 122 may use the financial service account maintained by financial service provider 110 to perform purchase transactions and make payments at various merchants (e.g., merchant 150), either online or at a point-of-sale location in the merchant location. Server 211 (e.g., processor 221) may be configured to receive the transaction data associated with the financial service accounts and compile them into consumer transaction data reflecting spending activities of a plurality of users (e.g., user 122).

In certain embodiments, server 111/211 (e.g., processor 221) may be configured to execute software instructions that enable it to receive the consumer transaction data from financial institution 130 (via server 131). For example, financial institution 130 may be an entity (e.g., a bank) that provides consumer transaction data. Financial institution 130 (via, e.g., server 131 or some other computer component) may collect data relating to consumer transaction data inducing, for example, the consumer transaction data associated with the financial service accounts that financial institution 130 and/or another entity generates and manages. Financial institution 130 (via, e.g., server 131) may be configured to provide the collected consumer transaction data to financial service provider 110 (via, e.g., server 111/211) for generating merchant recommendations.

In another aspect, server 211 (e.g., processor 221) may be configured to receive the consumer transaction data from a plurality of merchants such as, for example, merchant 150. Consumers who receive goods/services from merchant 150 may make the payment using a financial service account, such as a credit card account, debit card, etc., or other payment mechanism, such as cash. Merchant 150 (via, e.g., server 151) may be configured to generate and record the consumer transaction data associated with those purchase transactions and provide the consumer transaction data to financial service provider 110 (via, e.g., server 111/211) for use in generating merchant recommendations. In one aspect, merchant 150 may include point-of-sale computing systems that are configured to generate consumer transaction data and send that information to server 111/211. Server 211 (e.g., processor 221) may be configured to receive or collect the consumer transaction data (e.g., directly from the point-of-sale systems of merchant 150 or via server 151). As another example, server 211 (e.g., processor 221) may be configured to obtain the consumer transaction acts from one or more payment processors (e.g., entities that handle electronic financial service account transactions for merchants such as merchant 150).

Additionally or alternatively, server 211 (e.g., processor 221) may be configured to collect electronic payment data from one or more payment-solution prowlers including, for example, Square, LevelUp, Google Wallet, and/or like. In some embodiments, server 211 (e.g., processor 221) may be configured to receive consumer transaction data from consumers. For example, the disclosed embodiments may include mechanisms that enable a consumer to link their financial service account(s) with financial service provider 110. For instance, financial service provider 110 (via, server 111/211) may be configured to execute software processes that provide a way for a consumer to link its financial service account(s) with financial service provider 110 via, for example, website or online portal or smart phone applications. In certain embodiments, financial service provider 110 (via, e.g., server 111/211) may be configured to allow consumers to link their financial service account(s) with financial service provider 110 even though they are not the customers of financial service provider 110. By linking the financial service accounts, server 211 (e.g., processor 221) may be configured to gather the consumer transaction data associated with these consumers.

Financial service provider 110 (via, e.g., server 111/211) may be configured to link consumers' financial service account(s) with financial service provider 110 through various mechanisms. In some embodiments, if a consumer has a financial account with a financial service provider (e.g., a bank, credit card company, etc.) different from financial service provider 110, financial service provider 110 (via, e.g., server 111/211) may be configured to use an API (application programming interface) or other interface software, which may be provided by the systems (e.g., a server) of the different financial service provider, to access the consumer's transaction data. In another embodiment, financial service provider 110 (via, e.g., server 111/211) may be configured to apply screen scraping technology to pull transaction data directly from the consumer's financial accounts associated with the different financial service provider. For example, with the consumer's permission, financial service provider 110 (via, e.g., server 111/211) may be configured to use the consumer's credential to pull transaction data associated with the consumer's financial account directly from the website provided by the systems (e.g., a server) of the different financial service provider.

In certain embodiments, server 211 (e.g., processor 221) may be configured to process and store the received consumer transaction data that may be used for generating merchant recommendations for a user (e.g., step 320). In exemplary embodiments, for each transaction included in the consumer transaction data collected by server 211 (e.g., processor 221), it may contain information including, for example, the transaction date/time, the purchase amount, the unique customer identifier associated with the transaction, merchant attributes, consumer attributes (e.g., age, income, location etc.), customer-merchant relationship attributes (e.g., frequency of purchase, share of wallet, relative spending rank, relative loyalty, etc.), a category code associated with the merchant (e.g., retail goods, medical services, dining), a phone number associated with the merchant, a bank number associated with the merchant, and one or more geographic indicators (e.g., postal code, street address, city, state, GPS coordinates, etc.), and/or the like.

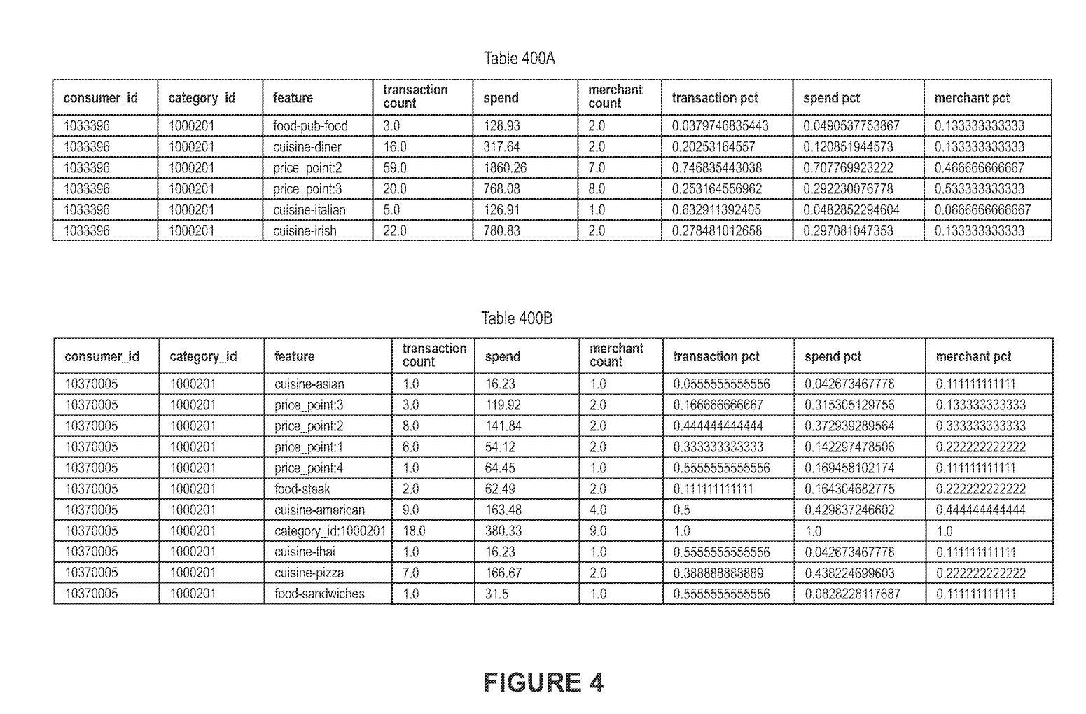

In certain embodiments, server 211 (e.g., processor 221) may be configured to store the consumer transaction data in one or more databases (e.g., database 227). In one aspect, server 211 (e.g., processor 221) may be configured to store the consumer transaction data in a database (e.g., database 227) that includes a plurality of data structures. FIG. 4 illustrates tables 400A and 400B included in a database (e.g., database 227) that store exemplary consumer transaction data. In one aspect, tables 400A and 400B may each include consumer transaction data associated with a particular consumer (e.g., consumer_id 1033393 as shown in table 400A and consumer_id 10370005 as shown in table 400B). In one aspect, exemplary tables 400A and 400B may each be organized with rows and columns. In one embodiment, columns of tables 400A and 400B may include, for example, consumer_id, category_id, feature, visit frequency (e.g., transaction count), purchase volume (e.g., spend), merchant count, transaction percentage, spend percentage, and/or merchant percentage. In another embodiment, rows of tables 400A and 400B may include, for example, the spending activities of a particular consumer at a plurality of merchants who have certain features (e.g., food-pub-food) and belong to a certain category (e.g., category_id, 1000201). In some embodiments, server 211 (e.g., processor 221) may be configured to store the consumer transaction data based on the attributes of one or more merchants (e.g., the category and the feature of merchant in tables 400A and 400B). In other embodiments, server 211 (e.g., processor 221) may be configured to store the consumer transaction data in the plurality of data structures based on a plurality of other factors (e.g., purchase volume).

In some embodiments, merchant attributes may overlap (e.g., “Irish” and “Pub,” “Chinese” and “Asian,” etc.). To address overlapping merchant attributes, server 211 (e.g., processor 221) may be configured to execute software instructions that perform factorization techniques (e.g., singular value decomposition (SVD)) to identify synthetic merchant attributes that are independent of each other for purpose of identifying consumer tastes. In one aspect, a synthetic merchant attribute may be an overlapping attribute of one or more merchants. For example, restaurant A may serve Chinese cuisine, whereas restaurant B may serve Asian cuisine. In such case, server 211 (e.g., processor 221) may be configured to execute software to extract the dominant feature (e.g., “Asian cuisine”) and use the extracted dominant feature to identify both restaurants (e.g., “Asian cuisine”). Server 211 (e.g., processor 221) may be configured to execute software to perform processes other than SVD for identifying synthetic merchant attributes. Thus, server 211 (e.g., processor 221) may be configured to use other methods known to those skilled in the art to aggregate the consumer transaction data.

In some embodiments, server 211 (e.g., processor 221) may be configured to receive information associated with an individual transaction or relatively larger batches of consumer transaction data. Thus, server 211 (e.g., processor 221) may be configured to process and store the consumer transaction data individually or in relatively large batch. In some embodiments, server 211 (e.g., processor 221) may be configured to process and store the consumer transaction data in batches over a certain period of time (e.g., a week, two weeks, etc.). In one aspect, if server 211 (e.g., processor 221) processes and stores the consumer transaction data in batches, server 211 (e.g. processor 221) may be configured to parse the received consumer transaction data and store such data in database 227 in smaller groups of data structures. For example, server 211 (e.g., processor 221) may be configured to store the received consumer transaction data based on the merchant category code (e.g., tables 400A and 400B) ardor merchant location (e.g., zip code). The disclosed embodiments may be configured to store and structure the consumer transaction data in other ways that facilitate retrieving data from a database (e.g., database 227) for generating merchant recommendations.

In exemplary embodiments, server 211 (e.g., processor 221) may be configured to execute software instructions that match a merchant to one or more transactions included in the consumer transaction data (e.g., step 330). In some embodiments, the consumer transaction data may not be tagged with detailed merchant information (e.g., merchant identification and/or detailed description of a merchant). For example, for one or more transactions, the received consumer transaction data may not show the particular merchant associated with the transactions, and/or the description of the merchant may not be complete and/or accurate. To address this problem, server 211 (e.g., processor 221) may be configured to pre-store merchant information (“merchant directory”) in one or more databases (e.g., database 227). In some embodiments, financial service provider 110 may purchase the merchant directory from a third party and store (via, e.g., server 111/211) the purchased merchant directory in one or more databases (e.g., database 227). In other embodiments, server 111/211 (e.g., processor 221) may be configured to collect information associated with merchants and store the collected information in one or more databases (e.g., database 227). The pre-stored merchant directory may include merchant information such as, for example, merchant identification number, detailed merchant description, merchant category code, merchant location, and/or the like.

In one aspect, server 211 (e.g., processor 221) may be configured to compare the merchant information (e.g., merchant category code, merchant location, and/or the like) associated with one or more transactions included in the consumer transaction data to the pre stored merchant directory. For example, information associated with a transaction included in the consumer transaction data may show that a user (e.g., user 122) purchased a cup of coffee in a certain location; however, information regarding the specific merchant (e.g., coffee store) is not included in the consumer transaction data. Using the location of the merchant, server 211 (e.g., processor 221) may be configured to search the merchant directory to find one or more coffee shops that may match the purchase made by user 122. In one embodiment, based on other information related to the merchant (e.g., detailed description), server 211 (e.g., processor 221) may be configured to find a particular merchant that matches the one or more transactions included the consumer transaction data.

In some embodiments, if server 211 (e.g., processor 221) matches the merchant entity to one or more transactions included in the consumer transaction data, it may be configured to execute software instructions to update data structure(s) in database 227 by adding information relating to the merchant that matches the one or more transactions. In one embodiment, information relating to the merchant may include, for example, a unique merchant entity identifier, more detailed business description, geocode (e.g., latitude and longitude), and/or the like. For example, server 211 (e.g., processor 221) may be configured to update tables 400A and/or 400B as shown in FIG. 4 by adding unique merchant entity identifier(s).

In exemplary embodiments, server 211 (e.g., processor 221) may be configured to execute software instructions to calculate one or more statistics based on the stored consumer transaction data (e.g. step 340). In one aspect, server 211 (e.g., processor 221) may be configured to calculate absolute statistics. In some embodiments, absolute statistics may be statistics that are calculated based on absolute values such as, for example, the purchase frequencies and/or purchase volume of a consumer at a merchant. For based on merchant identifiers and customer identifiers associated with the consumer transaction data, server 211 (e.g., processor 221) may be configured to determine the purchase frequency (e.g., how many times a consumer visits a merchant) and/or the purchase volume (e.g., how much money the consumer spent at this merchant).

In another aspect, server 211 (e.g., processor 221 may be configured to calculate comparative statistics. In some embodiments, comparative statistics may be statistics calculated by taking into account one or more merchants associated with the consumer transaction data, and may involve a comparison among the one or more merchants with respect to the spending activities of the consumer. For example, server 211 (e.g., processor 221) may be configured to determine the purchase volume and the purchase frequency of a particular consumer at one or more merchants, and compare the spending activities of the consumer with respect to one of those merchants with the spending activities of the consumer with respect to other merchants. In some embodiments, server 211 (e.g., processor 221) may be configured to select certain merchants for calculating the comparative statistics. For example, server 211 (e.g., processor 221) may be configured to select the merchants based on information including, for example, the category and/or the geography of the merchants. In other aspects, server 211 (e.g., processor 221) may be configured to use other information to select the merchants used for calculating the comparative statistics.

In exemplary embodiments, server 211 (e.g., processor 221) may be configured to generate merchant recommendations based on the consumer transaction data (e.g., step 350). As provided above, server 211 (e.g., processor 221) may be configured to receive and process the consumer transaction data, and store the consumer transaction data in one or more databases (e.g., database 227). In some embodiments, to improve the speed of searching for merchant candidates to be recommended to a consumer, server 211 (e.g., processor 221) may be configured to format the consumer transaction data in database 227 into one or more searchable formats.

In one embodiment, server 211 (e.g., processor 221) may be configured to create one or more indexes to improve the speed of retrieving merchants information from the plurality of data structures containing consumer transaction data. In one aspect, server 211 (e.g., processor 221) may be configured to use one or more contents associated with the columns of a data structure that stores the received consumer transaction data to create the one or more indexes (e.g., merchant locations and/or category_id shown in table 400). In other embodiments, server 211 (e.g., processor 221) may be configured to create indexes using methods known to those skilled in the art that may be used for querying and retrieving data (e.g., consumer transaction data) from a database (e.g., database 227).

In one embodiment, server 211 (e.g., processor 221) may be configured to create a merchant index based on merchant categories and generate merchant recommendations based on a particular merchant category that a user (e.g., user 122) may need. For example, user 122 may need to find a restaurant. In such case, server 211 (e.g., processor 221 may be configured to receive (via, e.g., I/O 222) the merchant category (e.g., “restaurant”) that user 122 may be interested in getting recommendations, and query the one or more data structures in a database (e.g., database 227) based on that merchant category (e.g., category associated with the restaurant).

In another embodiment, if server 211 (e.g., processor 221) creates a merchant index based on the merchant locations, server 211 (e.g., processor 221) may be configured to query the one or more databases (e.g., database 227) storing the consumer transaction data based on a given location. For example, a user (e.g., user 122) may be interested in getting recommendations for merchants located in a particular neighborhood. In such case, server 211 (e.g., processor 221) may be configured to receive the location information from user 122 (via, e.g., I/O 222), and query one or more databases (e.g., database 227) based on the location user 122 may provide.

In some embodiments, server 211 (e.g., processor 221) may be configured to generate merchant recommendations in near real time. In one aspect, a user (e.g., user 122) may carry a portable electronic device (e.g., client 120), which executes an application that may be configured to receive merchant recommendations from server 211 (e.g., processor 221) in real time. In one aspect, user 122 may share the location of client 120 with server 211 (e.g., processor 221), and server 211 (e.g., processor 221) may be configured to detect the location of client 120 (i.e., the location of user 122) and generate merchant recommendations based on the detected location information. For example, server 211 (e.g., processor 221) may be configured to query one or more databases (e.g., database 227) storing the consumer transaction data based on the detected location.

In some embodiments, server 211 (e.g., processor 221) may be configured to generate merchant recommendations based on the time the recommendation is to be made. For example, server 211 (e.g., processor 221) may be configured to detect the time that a user (e.g., user 122) may be interested in getting the recommendations, For example, via an application installed on a portable electronic device that user 122 carries (e.g., client 120), server 211 (e.g., processor 221) may be configured to detect the time when user 122 requests merchant recommendations via client 122 (e.g., an application installed on client 122 for requesting and receiving merchant recommendations). In such case, server 211 (e.g., processor 221) may be configured to generate merchant recommendations based on the detected time. For example, if user 122 is interested in receiving recommendations for restaurants and server 211 (e.g., processor 221) detects that the request is made around lunch time (e.g., 12 p.m. to 3 p.m.), server 211 (e.g., processor 221) may be configured to query one or more databases (e.g., database 227) storing the consumer transaction data based on the business hours of the merchants (e.g., searching for merchants that are open for lunch).

In exemplary embodiments, server 211 (e.g., processor 221) may be configured to generate a recommendation score for each of the recommended merchants (e.g., step 360). For example, server 211 (e.g., processor 221) may be configured to generate a recommendation score for each of the merchants recommended in step 350. In some embodiments, a recommendation score may be a percentage score (e.g., 85/100), a scaled score (e.g., on a scale from 0 to 1), a star rating (e.g., one to five stars indicating the strength or recommendation), and/or phrases indicating the strength of each of the recommendations (e.g., “strongly recommended,” “least recommended” and etc.). In other embodiments, server 211 (e.g., processor 221) may be configured to use other ways to represent a recommendation score for a recommended merchant.

In some embodiments, server 211 (e.g., processor 221) may be configured to generate one or mere models for generating recommendation scores for the recommended merchants. In some embodiments, one or more models may be a plurality of data structures that are generated based on the consumer transaction data. For example, server 211 (e.g., processor 221) may be configured to generate a merchant affinity model, a content filtering model, and/or a collaborative filtering model for generating recommendation scores.

The merchant affinity model may reflect whether a consumer (e.g., user 122) likes a merchant based on the historical spending data of one or more consumers. In one aspect, the merchant affinity model may be a data structure that includes data such as, for example, a plurality of merchants that user 122 may have visited and/or conducted transactions with. In another aspect, the merchant affinity model may be configured to include a list of merchants that server 211 (e.g., processor 221) determines that a user may like. As provided above, based on the consumer transaction data, server 211 (e.g., processor 221) may be configured to calculate absolute statistics (i.e., the absolute statistics calculated in step 340). Based on the calculated absolute statistics, server 211 (e.g., processor 221) may be configured to determine one or more merchants that user 122 may like. For example, based on the visit frequencies and/or the purchase volume, server 211 (e.g., processor 221) may be configured to determine that user 122 may like merchants such as, for example, Starbucks® and Target®. In such case, server 211 (e.g., processor 221) may be configured to store these two merchants corresponding to user 122 in the merchant affinity model.

In another aspect, based on the calculated absolute statistics (visit frequencies and the purchase volume), server 211 (e.g., processor 221) may be configured to determine that another user (“user A”) may like merchants such as, for example, Starbucks® and Wal-Mart®. Because merchant affinity model reflects that user 122 and user A both like Starbucks®, server 211 (e.g., processor 221) may be configured to determine that user 122 and the user A may have similar tastes, and thus user 122 may also to go to Wal-Mart®.

In some embodiments, server 211 (e.g., processor 221) may be configured to predict the strength that user 122 may like a merchant (e.g., Wal-Mart®) based on a number of factors. For example, the factors may include the location of user 122, the similarity of spending activities between user 122 and the user A, the visit frequencies and spend volume of user 122 and the user A at Starbucks®, and/or their visit frequencies and spend volume at Target® and Wal-Mart® respectively. For example, if Wal-Mart® is among the merchants recommended to user 122 (e.g., one of the merchants determined to be recommend in step 350), and server 211 (e.g., processor 221) detects (via e.g., an application installed on client 120) that user 122 is currently at Starbucks®, server 211 (e.g., processor 221) may be configured to determine that it is highly likely that user 122 may want to go to Wal-Mart®. Accordingly, server 211 (e.g., processor 221) may be configured to generate a recommendation score for Wal-Mart® (e.g., percentage score 90, scaled score 0.9, a five-star rating, or “strongly recommended,” etc.).

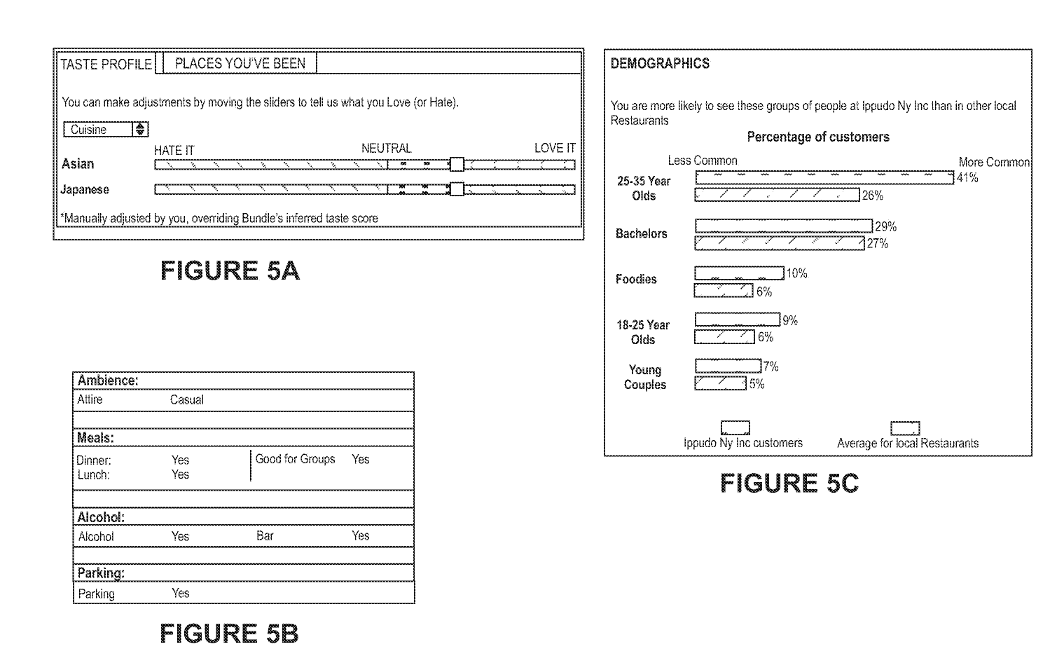

The content filtering model may reflect the preference profile of a user and the attributes of a merchant. In one embodiment, the content filtering model may be a data structure that includes a plurality of merchant attributes and the preference(s) the user explicitly provides. In some embodiments, server 211 (e.g., processor 221) may be configured to generate an interface screen on a computing device associated with user 122 (e.g., client 120), which may be configured to execute an application for receiving merchant recommendations from server 211 (e.g., processor 221). User 122 may provide, via the interface screen generated by server 211 (e.g., processor 221) on client 120, the preference(s) of user 122 with respect to a particular type of merchant (e.g., restaurant, grocery stores, etc.). FIG. 5A illustrates an interface screen by which user 122 may provide the preference(s). For example, user 122 may create a taste profile on the interface screen via client 120 with respect to cuisine types (e.g., Asian cuisine and/or Japanese cuisine) by indicating the degree of the preference (e.g., “hate it,” “neutral,” and/or “love it”). In another example, user 122 may provide the places that user 122 has visited. In other embodiments, user 122 may provide other information via the interface screen reflecting the preference(s) with respect to merchants.

In some embodiments, server 211 (e.g., processor 221) may be configured to gather the preference(s) of user 122 from sources including, for example, social networking sites (e.g., Facebook, Foursquare, and/or the like). For example, user 122 may write a message on Facebook indicating that user 122 likes a particular merchant. As another example, user 122 may “like” and/or “share” place on social networking sites (e.g., Facebook, Foursquare, and/or the like). In other embodiments, server 211 processor 221) may be configured to gather information relating to the preference(s) of user 122 with respect to one or more merchants from other information of user 122, such as, for example, a to-do list, the calendar, the check-in history at various social networking sites, and/or the like.

FIGS. 5B and 5C illustrate the plurality of the merchant attributes included in the content filtering model that server 211 (e.g., processor 221) may be configured to use for generating recommendation scores. As shown in FIGS. 5B and 5C, the merchant attributes may include, for example, ambience, meal choices provided, parking conditions, and demographics (percentage of customers and their respective age). In one aspect, server 211 (e.g., processor 221) may be configured to parse the plurality of the merchant attributes contained in the content filtering model based on the received preference(s) of a user (e.g., taste profile shown in FIG. 5A), and determine a recommendation score for the user with respect to each of the merchants to be recommended to the user. For example, if user 122 inputs, via the interface screen on client 120, information indicating that user 122 prefers a restaurant that serves Japanese Cuisine and provides parking, server 211 (e.g., processor 221) may be configured to parse the merchant attributes of a merchant (e.g., a merchant recommended in step 350) included in the content filtering model to determine whether the merchant serves Japanese cuisine and provides parking. Based on the parsing result, server 211 (e.g., processor 221) may be configured to determine the degree that user 122 may like the recommended merchant, and may accordingly generate a recommendation score. For example, the merchant serves Japanese cuisine and provides parking, server 211 (e.g., processor 221) may be configured to generate a high score for this merchant (e.g., percentage score of 90 or a four-star rating).

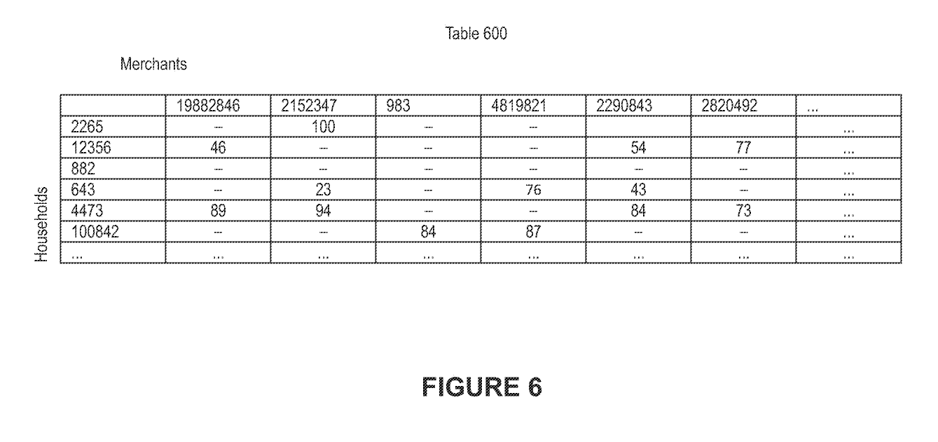

A collaborative filtering model may contain information reflecting the preferences of a plurality of consumers or household for a plurality of merchant. In some embodiments, server 211 (e.g., processor 221) may be configured to create a data structure containing the preferences of a plurality of users for a plurality of merchants. FIG. 6 illustrates an exemplary table 600 showing the preferences of a plurality of households (e.g., as identified by the households identifications) for a plurality of merchants (e.g., as identified by the merchant identification numbers). As shown in FIG. 6, the preferences of the households may be reflected by a plurality of percentage scores (e.g., 46, 89, and etc.). In one embodiment, the percentage scores may be determined based on the absolute statistics calculated at step 340. For example based on the visit frequency and the spending volume of a consumer (e.g., household 2265) at a merchant (e.g., merchant 2152347), server 211 (e.g., processor 221) may be configured to create a percentage score (e.g., 100) for this merchant. In another embodiment, the percentage scores (e.g., percentage score 94 shown in table 600) may be explicitly given by a user as a rating score.

In some embodiments, server 211 (e.g., processor 221) may be configured to use the collaborative filtering model to generate a recommendation score if server 211 does not possess any transaction data of a user (e.g., user 122). For example, if server 211 does not possess any transaction data of user 122, server 211 (e.g., processor 221) may be configured to use the spending activities of other users contained in the collaborative filtering model (e.g., table 600) to predict which merchant user 122 may like. In one embodiment, based on the preferences of one or more of the other users (e.g., household 2265 and household 4473) as reflected in the collaborative filtering model (e.g., table 600), server 211 (e.g., processor 221) may be configured to determine that user 122 may like a certain merchant that because one or more of the other users also like (e.g., merchant 2152347).

In some embodiments, server 211 (e.g., processor 221) may be configured to use one or more of the merchant affinity model, the content filtering model, and the collaborative filtering model to generate recommendation scores. If server 211 (e.g., processor 221) uses more than one model to generate recommendation scores, server 211 (e.g., processor 221) may be configured to combine the recommendation score generated by each model and normalize the combined recommendation scores. In some embodiments, different models may use different ways to indicate a recommendation score (e.g., percentage score, scaled score between 0 and 1, or phrases indicating the strength of the recommendations). In such case, server 211 (e.g., processor 221) may be configured to convert different types of recommendation scores into one cohesive type and then combine the scores. For example, server 211 (e.g., processor 221) may be configured to convert the recommendation scores generated by each model into percentage scores, and generate a final recommendation score by combining the converted percentage scores.

Additionally or alternatively, server 211 (e.g., processor 221) may be configured to generate a recommendation score by using other methods. In some embodiments, server 211 (e.g., processor 221) may be configured to generate a recommendation score based on information including, for example, the distances between a merchant and a consumer, the geography of a merchant, the category of a merchant, the visit frequency of a consumer with respect to a merchant in a certain period of time (e.g., how many times does a consumer visit a merchant in two years), and/or the like. Methods for generating recommendation scores are not limited to those provided above, and server 211 (e.g., processor 221) may be configured to use other method known to those skilled in the art for generating recommendation scores.

In exemplary embodiments, server 211 (e.g., processor 221) may be configured to provide the generated merchant recommendations and a recommendation score corresponding to each of the recommended merchants to a user (step 370). In some embodiments, server 211 (e.g., processor 221) may be configured to send the merchant recommendations via an application installed on a computing device (e.g., client 120). For example, the application installed on client 120 may be configured to programmatically interface with a web server (not shown) to request recommendations and obtain recommendations from server 211 (e.g., processor 221). In another embodiment, user 122 may log onto a website requesting merchant recommendations, and receive the merchant recommendations via a web page generated by server 211 (e.g., processor 221).

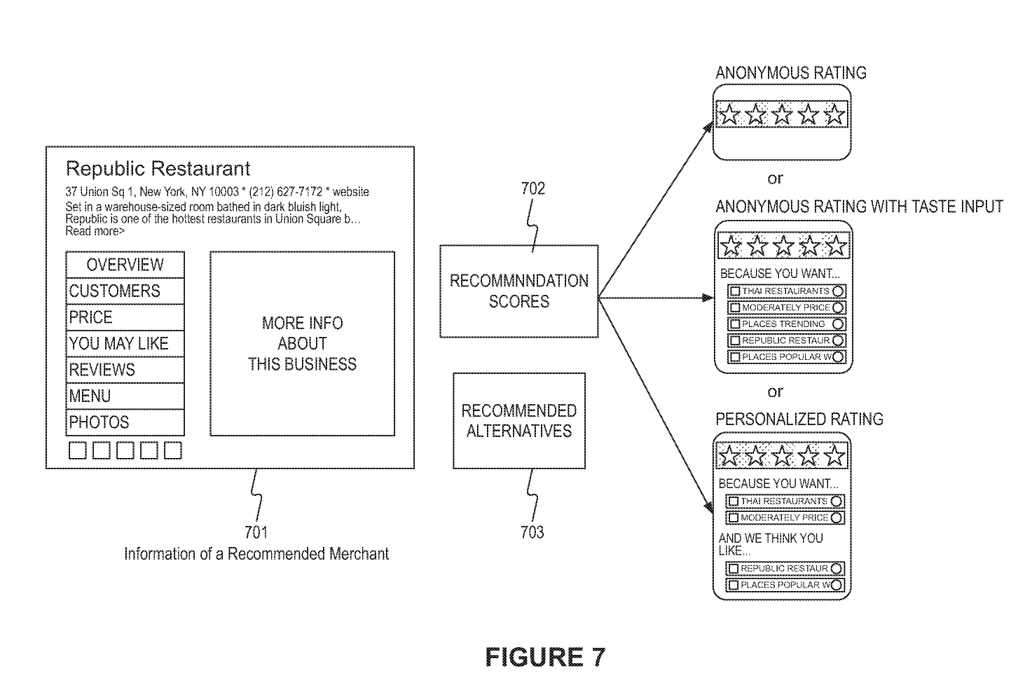

In some embodiments, server 211 (e.g., processor 221) may be configured to provide, along with the recommended merchants and the recommendation scores corresponding to each of the recommended merchants, other information including, for example, the description of the recommended merchants. FIG. 7 illustrates exemplary interface screen 700 that server 211 (e.g., processor 221) may generate for providing the recommended merchants and the recommendation scores to a user. For example, server 211 (e.g., processor 221) may generate an interface screen (e.g., interface screen 700) on client 120 for user 122. In some embodiments, interface screen 700 may illustrate a description of a recommended merchant 701, a recommendation score 702, recommended alternatives 703, and/or the like.

In some embodiments, interface screen 700 may be configured to provide a plurality of types of recommendation scores. For example, as shown in interface screen 700, depending on the basis for generating the recommendation score (e.g., a rating for a particular recommended merchant), the rating may be anonymous rating (e.g., rating generated based on the rating scores of other consumers using collaborative filtering model), anonymous rating with taste input (e.g., rating generated based on the preference of user 122 using content filtering model), or personalized rating (e.g., rating generated based on the preference of user 122 and analysis of the ratings scores of other consumers using both the collaborative filtering model and the content filtering model).

In one aspect, interface screen 700 may be configured to provide the basis for the rating provided. For example, as shown in FIG. 7, the anonymous rating with taste input may be generated based on the taste input of user 122 (e.g., “Thai restaurants,” “moderately priced,” “places trending,” “republic restaurant,” etc.). In another aspect, interface screen 700 may be configured to provide the basis for other methods for generating recommendation scores such as, for example, anonymous rating and/or personalized rating. Although interface screen 700 shows star-ratings, interface screen 700 may be configured to snow other typos of scores (e.g., percentage score, scaled score between 0 and 1, or phrases indicating the strength of the recommendations).

Additionally or alternatively, the disclosed embodiments can be used for purposes other than providing merchant recommendations to consumers. In some embodiments, server 211 (e.g., processor 221) may be configured to use the consumer transaction data to provide recommendations with respect to a particular product. In another embodiment, server 211 (e.g., processor 221) may be configured to use the consumer transaction data to provide offers, deals, or other promotional marketing recommendations. In certain aspects, server 211 (e.g., processor 221) may be configured to use the consumer transaction data to determine the proper consumers for online, mobile, or other interactive advertising. In another aspect, server 211 (e.g., processor 221) may be configured to use the context information of the consumers to improve real-time searching tools.

The disclosed embodiments may be associated with different types of financial services. Any financial institution that provides merchant recommendations to consumers may employ systems, methods, and articles of manufacture consistent with certain principles related to the disclosed embodiments. In addition, other types of entities, such as a merchant, retailer, or other type of corporate entity, may also employ systems, methods, and articles of manufacture consistent with certain disclosed embodiments.

In certain as servers 111, 131, and 151, and/or client 120, may be configured to execute software instructions that automatically perform one or more operations consistent with the disclosed embodiments.

Furthermore, although aspects of the disclosed embodiments are described as being associated with data stored In memory and other tangible computer-readable storage mediums, one skilled In the art appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above-described examples, but instead are defined by the appended claims in light of their full scope of equivalents.

1-20. (canceled)

21. A system for generating advertisements for a user, comprising:
one or more memory devices storing instructions; and
one or more processors configured to execute the instructions to:
receive consumer transaction data associated with a plurality of purchases of a user from at least one data source;
store the received consumer transaction data in the one or more memory devices according to a data structure having at least one column corresponding to a merchant attribute;
update the stored consumer transaction data to include merchant information for merchants associated with the user purchases;
generate one or more merchant indices for querying and retrieving data based on the updated consumer transaction data stored in the one or more memory devices, wherein the one or more indices are created using content associated with the column of the data structure;
generate a merchant affinity model based on the updated consumer transaction data retrieved using the one or more merchant indices, the merchant affinity model comprising comparative statistics of a plurality of merchants based on at least one of a frequency or a volume of the user purchases;
detect real time context information of a portable electronic device associated with the user;
identify a merchant recommendation based on the detected real time context information, the generated one or more merchant indices, and one or more merchant attributes;
receive an advertisement for the identified merchant recommendation based on the merchant affinity model; and
provide a signal to an application executed on the portable electronic device, the application being configured to display the advertisement.

22. The system of claim 21, wherein the one or more processors are further configured to execute the instructions to match the merchant to one or more transactions included in the stored consumer transaction data based on at least one of: merchant identification information reflected within the stored consumer transaction data or a comparison between the stored consumer transaction data and a merchant directory.

23. The system of claim 22, wherein the one or more processors are further configured to execute the instructions to:
update the consumer transaction data based on a result of matching the merchant to the one or more transactions included in the stored consumer transaction data.

24. The system of claim 21, wherein:
the real-time context information comprises a time period associated with providing the advertisement to the user;
the one or more attributes associated with the merchant comprises operating hours of the merchant; and
identifying the merchant recommendation comprises identification of a merchant with operating hours during the time period associated with providing the advertisement to the user.

25. The system of claim 21, wherein the merchant recommendation is further based on the merchant affinity model and at least one of a content filtering model or a collaborative filtering model.

26. The system of claim 25, wherein at least one of the merchant affinity model, the content filtering model, or the collaborative filtering model comprises a plurality of data structures generated based on at least the consumer transaction data.

27. The system of claim 21, wherein:
the real time context information comprises a determination of the location of the portable electronic device; and
the merchant recommendation is further based on an identification of merchants within a geographic proximity to the determined location of the electronic portable device.

28. The system of claim 21, wherein the advertisement is at least one of an online advertisement, a mobile advertisement, or an interactive advertisement.

29. A computer-implemented method for generating merchant recommendations for a user, comprising:
receiving, via at least one processor, consumer transaction data associated with a plurality of purchases from at least one data source;
storing the received consumer transaction data in the one or more memory devices according to a data structure having a column corresponding to an attribute associated with a merchant;
updating the stored consumer transaction data to include merchant information for merchants associated with the consumer purchases;
generating one or more merchant indices for querying and retrieving data based on the updated consumer transaction data stored in the one or more memory devices, wherein the one or more indices are created using content associated with the column of the data structure;
generating a merchant affinity model based on the updated consumer transaction data retrieved using the one or more merchant indices, the merchant affinity model including comparative statistics of a plurality of merchants based on a frequency and volume of the consumer purchases of the user;
detecting real time context information of a portable electronic device associated with the user;
identifying a plurality of merchant recommendations based on the detected real time context information, the generated one or more merchant indices, and one or more attributes associated with each of a plurality of merchants;
receiving an advertisement for each of the identified plurality of merchant recommendations; and
providing a signal to an application executed on the portable electronic device, the application being configured to display, the advertisement.

30. The method of claim 29, further comprising matching the merchant to one or more transactions included in the stored consumer transaction data based on at least one of: merchant identification information reflected within the stored consumer transaction data or a comparison between the stored consumer transaction data and a merchant directory.

31. The method of claim 30, further comprising updating the consumer transaction data based on a result of matching the merchant to the one or more transactions included in the stored consumer transaction data.

32. The method of claim 29, wherein:
the real time context information comprises a time period associated with providing the advertisement to the user; and
the one or more merchant attributes comprises merchant operating hours; and
identifying the merchant recommendation comprises identification of a merchant with operating hours during the time period associated with providing the advertisement to the user.

33. The method of claim 29, further comprising generating the merchant recommendation based on the merchant affinity model and at least one of a content filtering model or a collaborative filtering model.

34. The method of claim 33, wherein at least one of the merchant affinity model, the content filtering model, or the collaborative filtering model is a plurality of data structures generated based on the consumer transaction data.

35. The method of claim 29, wherein:
the real time context information comprises a determination of the location of the portable electronic device; and
the merchant recommendation is further based on an identification of merchants within a geographic proximity to the determined location of the electronic portable device.

36. The method of claim 29, wherein the advertisement is at least one of an online advertisement, a mobile advertisement, or an interactive advertisement.

37. A non-transitory computer-readable medium including instructions, which, when executed by a processor, cause the processor to perform a method for generating merchant recommendations for a user, the method comprising:
receiving, via at least one processor, consumer transaction data associated with a plurality of purchases from at least one data source;
storing the received consumer transaction data in the one or more memory devices according to a data structure having a column corresponding to an attribute associated with a merchant;
updating the stored consumer transaction data to include merchant information for merchants associated with the consumer purchases;
generating one or more merchant indices for querying and retrieving data based on the updated consumer transaction data stored in the one or more memory devices, wherein the one or more indices are created using content associated with the column of the data structure;
generating a merchant affinity model based on the updated consumer transaction data retrieved using the one or more merchant indices, the merchant affinity model including comparative statistics of a plurality of merchants based on at least one of a frequency or a volume of the consumer purchases of the user;
detecting real time context information of a portable electronic device associated with the user;
identifying a plurality of merchant recommendations based on the detected real time context information, the generated one or more merchant indices, and one or more attributes associated with each of a plurality of merchants;
receiving an advertisement for the identified merchant recommendations; and
providing a signal to an application executed on the portable electronic device, the application being configured to display the advertisement.

38. The medium of claim 37, wherein the method further comprises:
matching a merchant to one or more transactions included in the stored consumer transaction data based on at least one of:
merchant identification information reflected within consumer purchases associated with the stored consumer transaction data; or
a comparison between the stored consumer transaction data and a merchant directory; and updating the consumer transaction data based on a result of matching the merchant to the one or more transactions included in the stored consumer transaction data.

39. The method of claim 37, wherein the advertisements are at least one of an online advertisement, a mobile advertisement, or an interactive advertisement.

40. The method of claim 37, wherein:
the real time context information comprises a determination of the location of the portable electronic device; and
the merchant recommendation is further based on an identification of merchants within a geographic proximity to the determined location of the electronic portable device.
